(19) United States
(12) Patent Application Publication
(10) Pub. No.: US 2023/0278336 A1
(43) Pub. Date: Sep. 7, 2023

(54) DRIVE CIRCUIT, LIQUID JET HEAD, AND LIQUID JET RECORDING DEVICE

(71) Applicant: SII Printek Inc., Chiba-shi (JP)

(72) Inventor: Kensuke YOSHIDA, Chiba-shi (JP)

(21) Appl. No.: 18/172,882

(22) Filed: Feb. 22, 2023

(30) Foreign Application Priority Data
Mar. 1, 2022 (JP) 2022-031294

(51) Int. Cl. B41J 2/045

(52) U.S. Cl. CPC B41J 2/04588; B41J 2/04518

(57) ABSTRACT

There are provided a drive circuit and so on capable of controlling costs. A drive circuit according to an embodiment of the present disclosure is a circuit configured to output a drive signal to be applied to a liquid jet head, including a waveform storage section configured to store a plurality of pieces of waveform configuration information, a waveform selection section which is configured to select one of the plurality of pieces of waveform configuration information stored in the waveform storage section and which is configured to output the waveform configuration information selected as selected waveform configuration information, and a signal generation section configured to generate the drive signal configured to jet liquid based on the selected waveform configuration information output from the waveform selection section and an image datum input from an outside of the liquid jet head. The waveform selection section selects the selected waveform configuration information from the plurality of pieces of waveform configuration information using one of a first configuration signal set in advance, and a second configuration signal defined by an additional data signal included in the image datum.

### RELATED APPLICATIONS

This application claims priority to Japanese Patent Application No. 2022-031294 filed on Mar. 1, 2022, the entire content of which is incorporated herein by reference.

### BACKGROUND OF THE INVENTION

### 1. Field of the Invention

The present disclosure relates to a drive circuit, a liquid jet head, and a liquid jet recording device.

### 2. Description of the Related Art

Liquid jet recording devices equipped with liquid jet heads are used in a variety of fields, and a variety of types of liquid jet heads have been developed (see, e.g., JP2006-240048A).

In such a liquid jet head, in general, it is required to hold down the costs.

It is desirable to provide a drive circuit, a liquid jet head, and a liquid jet recording device capable of holding down the costs.

### SUMMARY OF THE INVENTION

A drive circuit according to an embodiment of the present disclosure is a circuit configured to output a drive signal to be applied to a liquid jet head, including a waveform storage section configured to store a plurality of pieces of waveform configuration information, a waveform selection section which is configured to select one of the plurality of pieces of waveform configuration information stored in the waveform storage section, and which is configured to output the waveform configuration information selected as selected waveform configuration information, and a signal generation section configured to generate the drive signal configured to jet liquid based on the selected waveform configuration information output from the waveform selection section and an image datum input from an outside of the liquid jet head. The waveform selection section selects the selected waveform configuration information from the plurality of pieces of waveform configuration information using one of a first configuration signal set in advance, and a second configuration signal defined by an additional data signal included in the image datum.

A liquid jet head according to an embodiment of the present disclosure includes the drive circuit according to the embodiment of the present disclosure, and a jet section which is configured to jet the liquid based on the drive signal output from the drive circuit, and which has a plurality of nozzles.

A liquid jet recording device according to an embodiment of the present disclosure includes the liquid jet head according to the embodiment of the present disclosure.

According to the drive circuit, the liquid jet head, and the liquid jet recording device related to the embodiment of the present disclosure, it becomes possible to control the costs.

### BRIEF DESCRIPTION OF THE DRAWINGS

FIG. 1 is a block diagram showing an outline configuration example of a liquid jet device according to an embodiment of the present disclosure.

FIG. 2 is a perspective view schematically showing an outline configuration example of a liquid jet head shown in FIG. 1.

FIG. 3 is a cross-sectional view schematically showing a configuration example of the liquid jet head shown in FIG. 2.

FIG. 4 is a block diagram showing a detailed configuration example of the liquid jet device shown in FIG. 1.

FIG. 5 is a schematic diagram showing a planar configuration example of a nozzle plate shown in FIG. 4.

FIG. 6 is a block diagram showing a configuration example of a drive circuit shown in FIG. 4.

FIG. 7 is a block diagram showing a configuration example of a waveform storage section shown in FIG. 6.

FIG. 8 is a block diagram showing a configuration example of a waveform selection circuit shown in FIG. 6.

FIG. 9 is a block diagram showing a configuration example of a drive switch circuit shown in FIG. 6.

FIG. 10A and FIG. 10B are a timing chart showing an example of a drive signal in which a plurality of types of waveform configuration is made.

FIG. 11A and FIG. 11B are a timing chart showing another example of the drive signal in which a plurality of types of waveform configuration is made.

FIG. 12A and FIG. 12B are a timing chart showing another example of the drive signal in which a plurality of types of waveform configuration is made.

FIG. 13 is a block diagram showing a configuration example of a liquid jet device according to a modified example.

### DETAILED DESCRIPTION OF THE PREFERRED EMBODIMENTS

An embodiment of the present disclosure will hereinafter be described in detail with reference to the drawings. It should be noted that the description will be presented in the following order:
1. Embodiment (an example of selecting waveform configuration information using one of two types of configuration signals)
2. Modified Example (an example in which it is arranged that a head configuration storage section is further disposed)
3. Other Modified Examples

### 1. Embodiment

### [Outline Configuration of Printer 5]

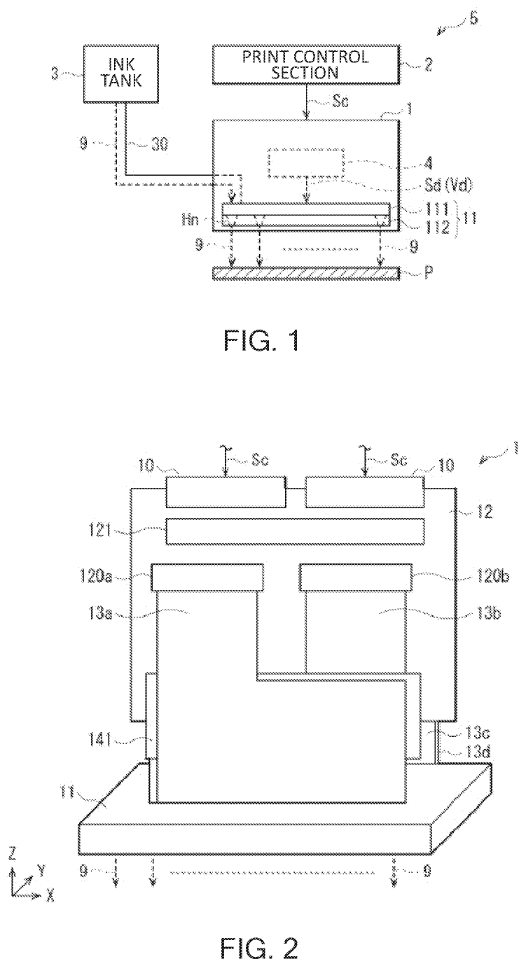

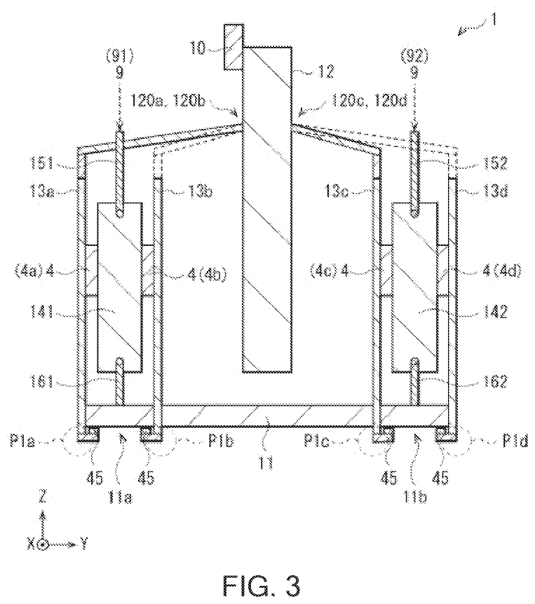

FIG. 1 is a block diagram showing an outline configuration example of a printer 5 as a liquid jet recording device according to an embodiment of the present disclosure. FIG. 2 is a perspective view schematically showing an outline configuration example of an inkjet head 1 as a liquid jet head shown in FIG. 1. FIG. 3 is a cross-sectional view (a Y-Z cross-sectional view) schematically showing a configuration example of the inkjet head 1 shown in FIG. 2. It should be noted that a scale size of each of the members is accordingly altered so that the member is shown in a recognizable size in the drawings used in the description of the present specification.

The printer 5 is an inkjet printer for performing recording (printing) of images, characters, and the like on a recording target medium (e.g., recording paper P shown in FIG. 1) using ink 9 described later. As shown in FIG. 1, the printer 5 is provided with the inkjet head 1, a print control section 2, and an ink tank 3.

It should be noted that the inkjet head 1 corresponds to a specific example of a “liquid jet head” in the present disclosure, and the printer 5 corresponds to a specific example of a “liquid jet recording device” in the present disclosure. Further, the ink 9 corresponds to a specific example of a “liquid” in the present disclosure.

### (A. Print Control Section 2)

The print control section 2 is for supplying the inkjet head 1 with a variety of types of information (data). Specifically, as shown in FIG. 1, the print control section 2 is arranged to supply each of constituents (drive devices 4 described later and so on) in the inkjet head 1 with a print control signal Sc.

It should be noted that the print control signal Sc is arranged to include, for example, image data Dp, an ejection timing signal St, a head configuration signal Ss, and a power supply voltage Vp (a drive power supply) for making the inkjet head 1 operate described later. Further, the print control section 2 corresponds to a specific example of an “outside of a liquid jet head” in the present disclosure.

### (B. Ink Tank 3)

The ink tank 3 is a tank for containing the ink 9 inside. As shown in FIG. 1, the ink 9 in the ink tank 3 is arranged to be supplied to the inside (a jet section 11 described later) of the inkjet head 1 via an ink supply tube 30. It should be noted that such an ink supply tube 30 is formed of, for example, a flexible hose having flexibility.

### (C. Inkjet Head 1)

The inkjet head 1 is a head for jetting (ejecting) the ink 9 shaped like a droplet from a plurality of nozzle holes Hn described later to the recording paper P as represented by dotted arrows in FIG. 1 to thereby perform recording of images, characters, and so on. As shown in, for example, FIG. 2 and FIG. 3, the inkjet head 1 is provided with a single jet section 11, a single I/F (interface) board 12, four flexible boards 13a, 13b, 13c, and 13d, two cooling units 141, 142, two ink entrance parts 151, 152, and two ink introduction parts 161, 162.

### (C-1. I/F Board 12)

As shown in FIG. 2 and FIG. 3, the I/F board 12 is a board intervening between an outside (the print control section 2) of the inkjet head 1 and the flexible boards 13a, 13b, 13c, and 13d. The I/F board 12 is provided with two connectors 10, four connectors 120a, 120b, 120c, and 120d, and a circuit arrangement area 121.

As shown in FIG. 2, the connectors 10 are each a part (a connector part) for inputting the print control signal Sc which is described above, and which is supplied from the print control section 2 toward the inkjet head 1 (the flexible boards 13a, 13b, 13c, and 13d described later).

The connectors 120a, 120b, 120c, and 120d are parts (connector parts) for electrically coupling the I/F board 12 and the flexible boards 13a, 13b, 13c, and 13d, respectively.

The circuit arrangement area 121 is an area where a variety of circuits are arranged on the I/F board 12. It should be noted that it is also possible to arrange that such a circuit arrangement area is also disposed in other areas on the I/F board 12.

### (C-2. Jet Section 11)

As shown in FIG. 1, the jet section 11 is a part which has the plurality of nozzle holes Hn, and which jets the ink 9 from these nozzle holes Hn. Further, in the example shown in FIG. 3, it is arranged that the ink 9 (e.g., first ink 91 described later) supplied via the ink entrance part 151 and the ink introduction part 161 is jetted from a jet part 11a in the jet section 11. Similarly, it is arranged that the ink 9 (e.g., second ink 92 described later) supplied via the ink entrance part 152 and the ink introduction part 162 is jetted from a jet part 11b in the jet section 11. Such jet of the ink 9 is arranged to be performed (see FIG. 1) in accordance with drive signals Sd (drive voltages Vd) supplied from the drive devices 4 described later on each of the flexible boards 13a, 13b, 13c, and 13d.

As shown in FIG. 1, such a jet section 11 is configured including an actuator plate 111 and a nozzle plate 112.

### (Nozzle Plate 112)

The nozzle plate 112 is a plate formed of a film material such as polyimide, or a metal material, and has the plurality of nozzle holes Hn described above as shown in FIG. 1. These nozzle holes Hn are formed side by side at predetermined intervals, and each have, for example, a circular shape.

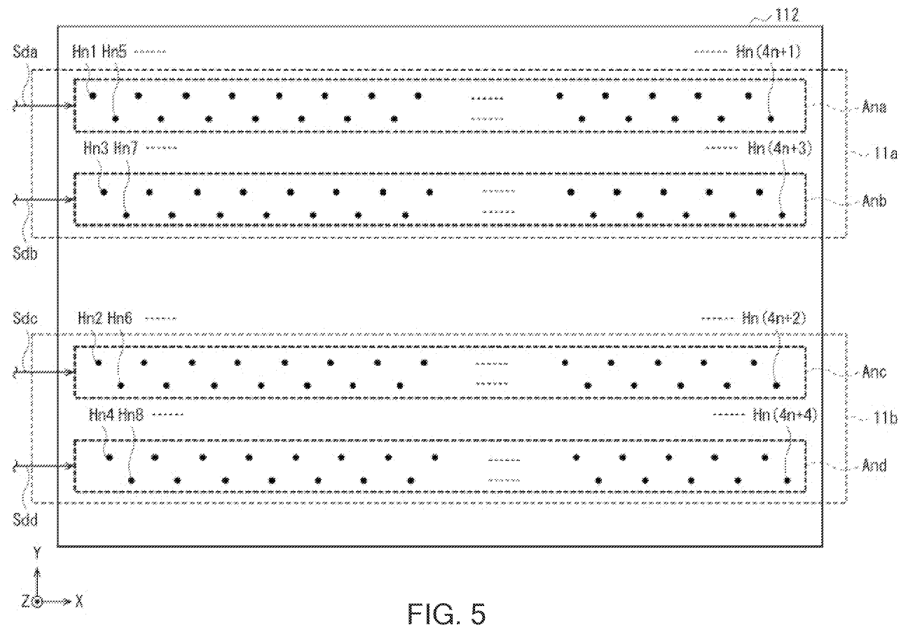

Specifically, although described later in detail (FIG. 5), in the example of the jet section 11 shown in FIG. 2, the plurality of nozzle holes Hn in the nozzle plate 112 is constituted by a plurality of nozzle arrays (four nozzle arrays described later) each arranged along a column direction (an X-axis direction). Further, these two or more nozzle arrays are arranged side by side along a direction (a Y-axis direction) perpendicular to the column direction.

### (Actuator Plate 111)

The actuator plate 111 is a plate formed of a piezoelectric material such as PZT (lead zirconate titanate). The actuator plate 111 is provided with a plurality of channels (pressure chambers). These channels are each a part for applying pressure to the ink 9, and are arranged side by side so as to be parallel to each other at predetermined intervals. Each of the channels is partitioned with drive walls (not shown) formed of a piezoelectric body, and forms a groove part having a recessed shape in a cross-sectional view.

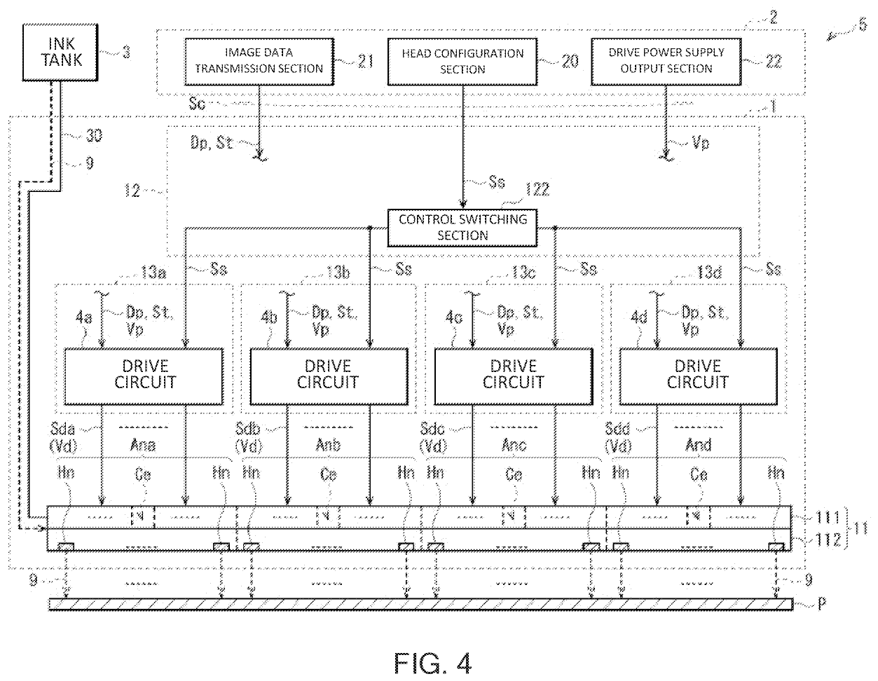

As such channels, there exist ejection channels Ce (see FIG. 4 described later) for ejecting the ink 9, and dummy channels (non-ejection channels) which do not eject the ink 9. In other words, it is arranged that the ejection channels Ce are filled with the ink 9 on the one hand, but the dummy channels are not filled with the ink 9 on the other hand. It should be noted that it is arranged that filling of each of the ejection channels Ce with the ink 9 is performed via, for example, a flow channel (a common flow channel) commonly communicated with such ejection channels Ce. Further, it is arranged that each of the ejection channels Ce is individually communicated with the nozzle hole Hn in the nozzle plate 112 on the one hand, but each of the dummy channels is not communicated with the nozzle hole Hn on the other hand. These ejection channels Ce and the dummy channels are alternately arranged side by side along the column direction (the X-axis direction) described above.

Further, on the inner side surfaces opposed to each other in the drive wall described above, there are respectively disposed drive electrodes. As the drive electrodes, there exist common electrodes disposed on the inner side surfaces facing the ejection channels Ce, and active electrodes (individual electrodes) disposed on the inner side surfaces facing the dummy channels. These drive electrodes and the drive devices 4 described later are electrically coupled to each other via each of the flexible boards 13a, 13b, 13c, and 13d. Thus, it is arranged that the drive voltages Vd (the drive signals Sd) described above are applied to the drive electrodes from the drive devices 4 via each of the flexible boards 13a, 13b, 13c, and 13d (see FIG. 1).

### (C-3. Flexible Boards 13a, 13b, 13c, and 13d)

The flexible boards 13a, 13b, 13c, and 13d are each a board for electrically coupling the I/F board 12 and the jet section 11 to each other as shown in FIG. 2 and FIG. 3. It is arranged that these flexible boards 13a, 13b, 13c, and 13d individually control the jet actions of the ink 9 in the four nozzle arrays in the nozzle plate 112 described above, respectively. Further, as indicated by, for example, the reference symbols P1a, P1b, P1c, and P1d in FIG. 3, it is arranged that the flexible boards 13a, 13b, 13c, and 13d are folded around places (around clamping electrodes 45) where the flexible boards 13a, 13b, 13c, and 13d are coupled to the jet section 11, respectively. It should be noted that it is arranged that electrical coupling between the clamping electrodes 45 and the jet section 11 is achieved by, for example, thermocompression bonding using an ACF

### (Anisotropic Conductive Film).

On each of such flexible boards 13a, 13b, 13c, and 13d, there are individually mounted (see FIG. 3) the drive devices 4 (drive circuits 4a to 4d). Specifically, the drive circuit 4a is arranged on the flexible board 13a, the drive circuit 4b is arranged on the flexible board 13b, the drive circuit 4c is arranged on the flexible board 13c, and the drive circuit 4d is arranged on the flexible board 13d. These drive devices 4 (the drive circuits 4a to 4d) are each a device (a circuit) for outputting the drive signals Sd (the drive voltages Vd) for jetting the ink 9 from the nozzle holes Hn in the corresponding nozzle array in the jet section 11. Therefore, it is arranged that such drive signals Sd are output from each of the flexible boards 13a, 13b, 13c, and 13d to the jet section 11. It should be noted that such drive devices 4 are each formed of, for example, an ASIC (Application Specific Integrated Circuit).

Further, these drive devices 4 are arranged to be cooled by the cooling units 141, 142 described above. Specifically, as shown in FIG. 3, the cooling unit 141 is fixedly disposed between the drive devices 4 on the flexible boards 13a, 13b, and by pressing the cooling unit 141 against each of these drive devices 4, the drive devices 4 are cooled. Similarly, the cooling unit 142 is fixedly disposed between the drive devices 4 on the flexible boards 13c, 13d, and by pressing the cooling unit 142 against each of these drive devices 4, the drive devices 4 are cooled. It should be noted that such cooling units 141, 142 can each be configured using a variety of types of cooling mechanisms.

### [Detailed Configuration of Printer 5]

Then, the detailed configuration example of the printer 5 will be described with reference to FIG. 4, FIG. 5.

FIG. 4 is a block diagram showing the detailed configuration example of the printer 5. Further, FIG. 5 is a schematic diagram showing a planar configuration example (an X-Y planar configuration example) of the nozzle plate shown in FIG. 4.

As shown in FIG. 4, the print control section 2 described above has a head configuration section 20, an image data transmission section 21, and a drive power supply output section 22.

The head configuration section 20 is for outputting the head configuration signals Ss for performing a variety of types of settings (setting of the drive waveform, operation setting, and so on) in the inkjet head 1 respectively to the drive circuits 4a to 4d described above on the flexible boards 13a to 13d via a control switching section 122 (see FIG. 4) disposed on the I/F board 12. The image data transmission section 21 is for transmitting the image data Dp and the ejection timing signal St described above to the drive circuits 4a to 4d on each of the flexible boards 13a to 13d via the I/F board 12. The drive power supply output section 22 is for outputting the power supply voltage Vp (the drive power supply) described above to the drive circuits 4a to 4d on each of the flexible boards 13a to 13d via the I/F board 12.

Such image data Dp, ejection timing signal St, head configuration signal Ss, and power supply voltage Vp as described above are each included in the print control signal Sc described above (see FIG. 4), and are arranged to be transmitted from the print control section 2 toward the I/F board 12 using predetermined high-speed differential transmission. It should be noted that such high-speed differential transmission is constituted using, for example, LVDS (Low Voltage Differential Signaling). It should be noted that it is possible for such high-speed differential transmission to be constituted using, for example, CML (Current Mode Logic) or ECL (Emitter Coupled Logic).

As shown in FIG. 4, the control switching section 122 described above is arranged to perform a predetermined control switch action when transmitting the head configuration signal Ss transmitted from the head configuration section 20 to each of the drive circuits 4a to 4d in the plurality of flexible boards 13a to 13d. Specifically, the control switching section 122 is arranged to transmit the head configuration signal Ss in parallel to the drive circuits 4a to 4d on the plurality of flexible boards 13a to 13d. It should be noted that on this occasion, the head configuration signal Ss is arranged to be transmitted using, for example, low-speed I²C (Inter-Integrated Circuit) communication.

Here, in the example shown in FIG. 5, the plurality of nozzle holes Hn in the nozzle plate 112 is separated (grouped) into four nozzle arrays Ana, Anb, Anc, and And respectively arranged along the column direction (the X-axis direction). The two nozzle arrays Ana, Anb are each arranged in the jet part 11a described above, and the two nozzle arrays Anc, And are each arranged in the jet part 11b described above. Further, these nozzle arrays Ana, Anb, Anc, and And are arranged side by side along the direction (the Y-axis direction) perpendicular to the column direction.

In particular, as shown in FIG. 5, in the nozzle array Ana, the nozzle holes Hn1, Hn5, Hn(4n+1) (n: an integer no smaller than 0) as the plurality of nozzle holes Hn are arranged in a zigzag manner forming a staggered arrangement along the Y-axis direction. Similarly, in the nozzle array Anb, the nozzle holes Hn3, Hn7, Hn(4n+3) as the plurality of nozzle holes Hn are arranged in a zigzag manner forming a staggered arrangement along the Y-axis direction. In the nozzle array Anc, the nozzle holes Hn2, Hn6, . . . , Hn(4n+2) as the plurality of nozzle holes Hn are arranged in a zigzag manner forming a staggered arrangement along the Y-axis direction. In the nozzle array And, the nozzle holes Hn4, Hn8, Hn(4n+4) as the plurality of nozzle holes Hn are arranged in a zigzag manner forming a staggered arrangement along the Y-axis direction.

It should be noted that such two or more nozzle holes Hn each correspond to a specific example of a “nozzle” in the present disclosure. Further, the nozzle arrays Ana, Anb, Anc, and described above each correspond to a specific example of a “nozzle group” in the present disclosure.

Here, the drive circuits 4a to 4d shown in FIG. 4 are each arranged to output the drive signal Sd for each of the nozzle arrays Ana to And. Specifically, the drive circuit 4a outputs the drive signal Sda as the drive signal Sd corresponding to the nozzle array Ana (the nozzle holes Hn1, Hn5, . . . , Hn(4n+1) shown in FIG. 5). Similarly, the drive circuit 4b outputs the drive signal Sdb as the drive signal Sd corresponding to the nozzle array Anb (the nozzle holes Hn3, Hn7, . . . , Hn(4n+3) shown in FIG. 5). The drive circuit 4c outputs the drive signal Sdc as the drive signal Sd corresponding to the nozzle array Anc (the nozzle holes Hn2, Hn6, . . . , Hn(4n+2) shown in FIG. 5). The drive circuit 4d outputs the drive signal Sdd as the drive signal Sd corresponding to the nozzle array And (the nozzle holes Hn4, Hn8, Hn(4n+4) shown in FIG. 5). It should be noted that the nozzle holes Hn in each of the nozzle arrays Ana, Anb, Anc, and shown in FIG. 4 are schematically shown while being arranged in a line in the nozzle plate 112 shown in FIG. 4 for the sake of convenience.

[Detailed Configuration of Drive Circuits 4a to 4d]

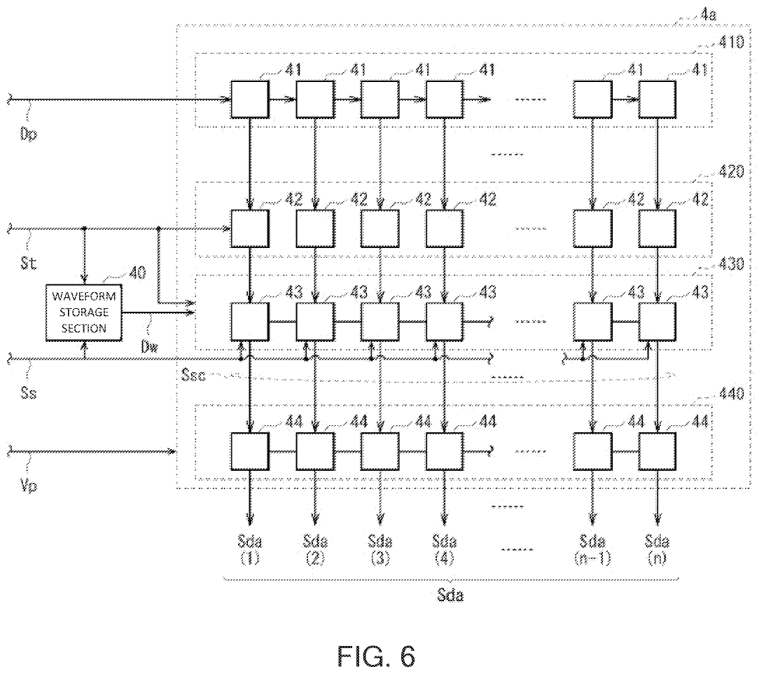

Then, the detailed configuration example of the drive circuits 4a to 4d described above will be described with reference to FIG. 6 to FIG. 9. It should be noted that in these FIG. 6 to FIG. 9, the detailed configuration example of the drive circuit 4a is shown as a representative, but the detailed configuration example of the drive circuits 4b to 4d are basically the same.

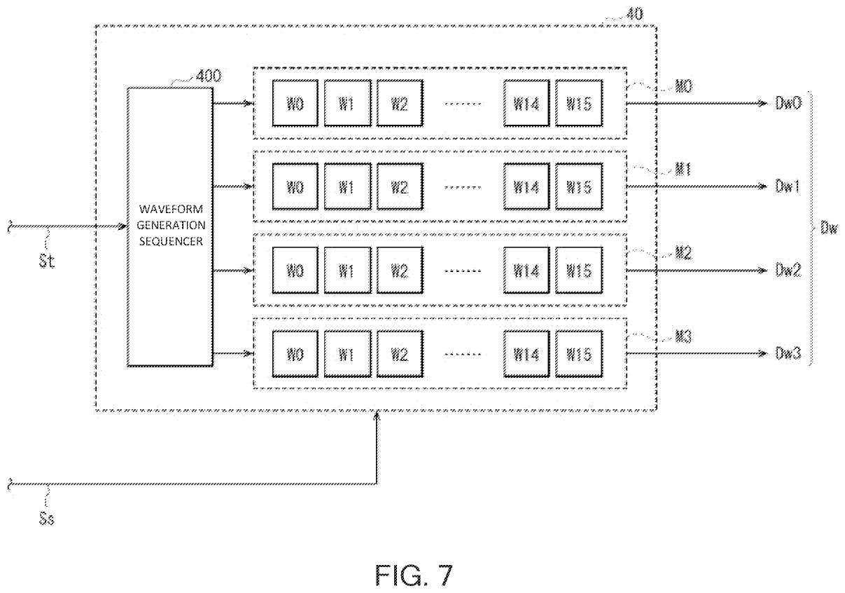

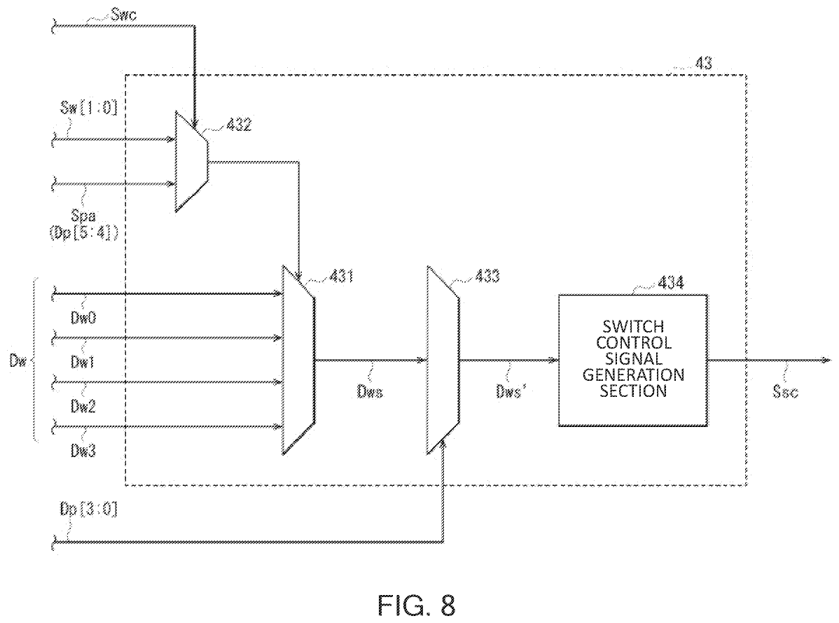

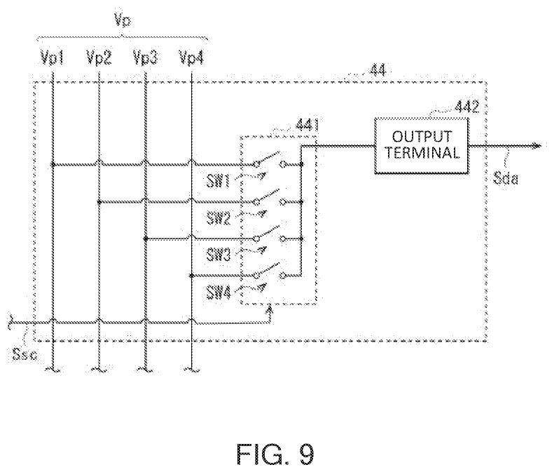

FIG. 6 is a block diagram showing a configuration example of the drive circuit 4a shown in FIG. 4. FIG. 7 is a block diagram showing a configuration example of the waveform storage section 40 described later and shown in FIG. 6. FIG. 8 is a block diagram showing a configuration example of the waveform selection circuit 43 described later and shown in FIG. 6. FIG. 9 is a block diagram showing a configuration example of the drive switch circuit 44 shown in FIG. 6.

As shown in FIG. 6, the drive circuit 4a has the waveform storage section 40, a shift register section 410, a latch circuit section 420, a waveform selection circuit section 430, and a drive switch circuit section 440.

As shown in FIG. 6, the shift register section 410 is a circuit for sequentially transmitting the image data Dp for the plurality of nozzle holes Hn from an anterior stage side toward a posterior stage in accordance with the drive signals Sd for the plurality of nozzle holes Hn, and then holding the image data Dp. The shift register section 410 has the same number (n in this example) of FF (flip-flop) circuits 41 as the number of the corresponding plurality of nozzle holes Hn, and it is made possible to hold, for example, 4-bit image datum Dp in each of the FF circuits 41.

As shown in FIG. 6, the latch circuit section 420 is a circuit for holding the image data Dp for the plurality of nozzle holes Hn output from the FF circuits 41 in the shift register section 410 in sync with the ejection timing signal St described above. The latch circuit section 420 has the same number (n in this example) of latch circuits 42 as the number of the corresponding plurality of nozzle holes Hn, and is made possible to hold, for example, 4-bit image datum Dp in each of the latch circuits 42.

As shown in FIG. 6, the waveform selection circuit section 430 is a circuit for generating switch control signals Ssc described later based on the image data Dp for the plurality of nozzle holes Hn output from the latch circuits 42 in the latch circuit section 420, the ejection timing signal St and the head configuration signal Ss described above, and waveform data Dw output from the waveform storage section 40 described later. The waveform selection circuit section 430 has the same number (n in this example) of waveform selection circuits 43 as the number of the corresponding plurality of nozzle holes Hn, and is arranged to generate the switch control signals Ssc for the plurality of nozzle holes Hn in the waveform selection circuits 43.

As shown in FIG. 6, the drive switch circuit section 440 is a circuit for generating the drive signals Sd (Sda) for the plurality of nozzles Hn based on the switch control signals Ssc for the plurality of nozzle holes Hn output from the waveform selection circuits 43 in the waveform selection circuit section 430. The drive switch circuit section 440 has the same number (n in this example) of drive switch circuits 44 as the number of the corresponding plurality of nozzle holes Hn. Further, the drive switch circuits 44 are arranged to respectively generate the drive signals Sda (Sda (1) to Sda (n)) having the drive voltages Vd corresponding respectively to the n nozzle holes Hn by performing conversion of signal levels (voltage values) based on such switch control signals Ssc and the power supply voltage Vp described above (see FIG. 6).

### (Waveform Storage Section 40)

The waveform storage section 40 is for storing a plurality of waveform data Dw hereinafter described. As shown in FIG. 6, it is arranged that the ejection timing signal St and the head configuration signals Ss are input to the waveform storage section 40, and at the same time, the waveform data Dw are output from the waveform storage section 40 toward the waveform selection circuit section 430 (the waveform selection circuits 43).

As shown in, for example, FIG. 7, the waveform storage section 40 has a waveform generation sequencer 400 and a plurality of (four in this example) waveform memories M0 to M3.

Each of the waveform memories M0 to M3 individually memorizes (stores) a plurality of (sixteen in this example) waveform data W0 to W15. In other words, the waveform storage section 40 stores (16×4)=64 waveform data as a whole. These waveform data W0 to W15 each correspond to waveform configuration information (waveform datum) for a single drive waveform. Such waveform data W0 to W15 are each arranged to be able to be written and read due to the head configuration signal Ss, and is arranged to be stored in the respective waveform memories M0 to M3 using the I²C communication from the head configuration section 20 described above.

The waveform generation sequencer 400 is for reading the waveform data W0 to W15 stored in the respective waveform memories M0 to M3 to output them as the waveform data Dw (Dw0 to Dw3) to the outside of the waveform storage section 40 when the ejection timing signal St is input. Specifically, as shown in FIG. 7, the waveform generation sequencer 400 outputs the waveform data W0 to W15 memorized in the waveform memory M0 as the waveform data Dw0, and outputs the waveform data W0 to W15 memorized in the waveform memory M1 as the waveform data Dw1. Similarly, the waveform generation sequencer 400 outputs the waveform data W0 to W15 memorized in the waveform memory M2 as the waveform data Dw2, and outputs the waveform data W0 to W15 memorized in the waveform memory M3 as the waveform data Dw3.

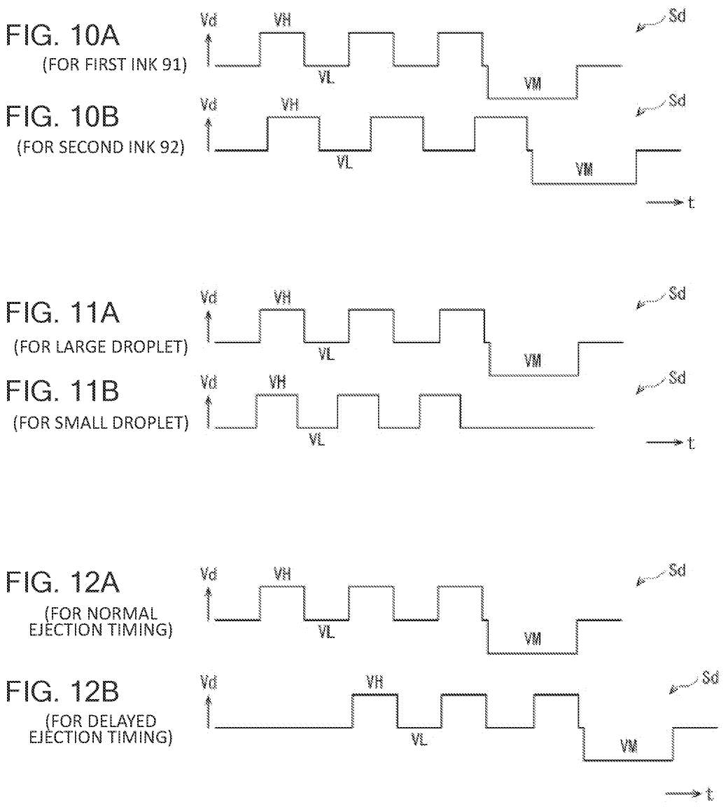

It should be noted that although the details will be described later (FIGS. 10A and 10B to FIGS. 12A and 12B), it is arranged that a variety of types of waveform data are included as such a plurality of waveform data W0 to W15 (the plurality of waveform data Dw) depending on the intended use. Specifically, it is arranged that there are included a variety of types of waveform data for, for example, individually ejecting a plurality of types of ink 9 (the ink types), making the ejection timing of the ink 9 different, and making a droplet volume (a volume range of the droplet) of the ink 9 different.

### (Waveform Selection Circuit 43)

The waveform selection circuits 43 shown in FIG. 6 each have three selectors (selection circuits) 431 to 433, and a switch control signal generation section 434 as shown in FIG. 8.

The selector 431 is a circuit for selecting one of the four types of waveform data Dw0 to Dw3 described above output from the waveform storage section 40, and then outputting the waveform data thus selected as selected waveform data Dws. In other words, the selector 431 is arranged to selectively output 16 waveform data (the waveform data W0 to W15 included in the selected waveform data Dws) out of the 64 (=16×4) waveform data included in the four types of waveform data Dw0 to Dw3.

As shown in FIG. 8, the selector 431 is arranged to select the selected waveform data Dws using a selection signal (one configuration signal of a waveform configuration signal Sw and an additional data configuration signal Spa) output from the selector 432 on this occasion. The waveform configuration signal Sw [1:0] is a 2-bit configuration signal defined by the head configuration signal Ss (a signal different from the additional data configuration signal Spa), and is a signal set in advance. On the other hand, as shown in FIG. 8, the additional data configuration signal Spa is a configuration signal defined by a 2-bit additional image datum Dp [5:4] as a datum added to the original image datum Dp (the 4-bit image datum Dp[3:0]). In other words, the additional data configuration signal Spa is defined by the additional image datum Dp[5:4] which is included in the image datum Dp[5:0] and which is separated from the original image datum Dp[3:0].

The selector 432 is a circuit for selectively outputting one configuration signal of the two types of configuration signals (the waveform configuration signal Sw and the additional data configuration signal Spa) described above to the selector 431 using a selection control signal Swc. In other words, the selection control signal Swc is a control signal for defining which configuration signal out of the waveform configuration signal Sw and the additional data configuration signal Spa is used (in the selector 431). It should be noted that the selection control signal Swc can be a signal included in, for example, the head configuration signal Ss, or can be a signal set from the outside of the inkjet head 1 using a pin (a terminal) in each of the drive circuits 4a to 4d.

The selector 433 is a circuit for selectively outputting one of the 16 waveform data W0 to W15 included in the selected waveform data Dws as selected waveform data Dws' based on the selected waveform data Dws output from the selector 431 and the original 4-bit image datum Dp [3:0] described above. In other words, the selector 433 is arranged to select one of the 16 (=24) waveform data W0 to W15 using the 4-bit image datum Dp[3:0].

The switch control signal generation section 434 is for generating the switch control signals Ssc to be used when generating the drive signals Sd based on the selected waveform data Dws' (finally selected one of the 64 waveform data) output from the selector 433. It should be noted that it is arranged that the switch control signals Ssc generated in such a manner are output to the drive switch circuits 44 hereinafter described.

### (Drive Switch Circuit 44)

The drive switch circuits 44 shown in FIG. 6 each have a drive switch section 441 including a plurality of (four in this example) drive switches SW1 to SW4, and an output terminal 442 as shown in, for example, FIG. 9. Further, it is arranged that a plurality of (four in this example) power supply voltages Vp1 to Vp4 as the power supply voltage (the drive power supply) supplied from the outside of the drive circuits 4a to 4d is supplied to the drive switch circuit 44.

As shown in FIG. 9, in the drive switch section 441, the drive switch SW1 is arranged on a line between the power supply voltage Vp1 and the output terminal 442, and the drive switch SW2 is arranged on a line between the power supply voltage Vp2 and the output terminal 442. Similarly, the drive switch SW3 is arranged on a line between the power supply voltage Vp3 and the output terminal 442, and the drive switch SW4 is arranged on a line between the power supply voltage Vp4 and the output terminal 442. Further, it is arranged that an ON state or an OFF state in each of the drive switches SW1 to SW4 is set based on the switch control signal Ssc supplied from the switch control signal generation section 434.

Specifically, when, for example, the drive switch SW1 is set to the ON state, and at the same time, the drive switches SW2 to SW4 are each set to the OFF state, the power supply voltage Vp1 is supplied to the output terminal 442 via the drive switch SW1, as a result. By the drive switches SW1 to SW4 performing the ON/OFF actions based on the switch control signal Ssc in such a manner, the voltage selected from the power supply voltages Vp1 to Vp4 is supplied to the output terminal 442 to thereby generate the drive signal Sd (the drive signal Sda in the example shown in FIG. 9). In other words, it is arranged that the drive signals Sd (Sda to Sdd) corresponding to the nozzle holes Hn are individually output from the drive switch circuits 44.

Here, the selectors 431, 432 in each of the waveform selection circuits 43 each correspond to a specific example of a “waveform selection section” in the present disclosure. Further, the selector 433 and the switch control signal generation section 434 in each of the waveform selection circuits 43 and each of the drive switch circuits 44 correspond to a specific example of a “signal generation section” in the present disclosure. The waveform data Dw1 to Dw4 each correspond to a specific example of the “waveform configuration information” in the present disclosure, and the selected waveform data Dws correspond to a specific example of “selected waveform configuration information” in the present disclosure. Further, the waveform configuration signal Sw (Sw[1:0]) corresponds to a specific example of a “first configuration signal” in the present disclosure, and the additional data configuration signal Spa corresponds to a specific example of a “second configuration signal” in the present disclosure. Further, the additional image datum Dp (Dp[5:4]) corresponds to a specific example of an “additional data signal” in the present disclosure.

### [Operations and Functions/Advantages]

### (A. Basic Operation of Printer 5)

In the printer 5, a recording operation (a printing operation) of images, characters, and so on to the recording target medium (the recording paper P and so on) is performed using such a jet operation of the ink 9 by the inkjet head 1 as described below. Specifically, in the inkjet head 1 according to the present embodiment, the jet operation of the ink 9 using a shear mode is performed in the following manner.

First, the drive devices 4 (the drive circuits 4a to 4d) on the respective flexible boards 13a, 13b, 13c, and 13d each apply the drive voltage Vd (the drive signal Sd) to the drive electrodes (the common electrode and the active electrode) described above in the actuator plate 111 in the jet section 11. Specifically, each of the drive devices 4 applies the drive voltage Vd to the drive electrodes disposed on the pair of drive walls partitioning the ejection channel Ce described above. Thus, the pair of drive walls each deform so as to protrude toward the dummy channel adjacent to the ejection channel Ce.

On this occasion, it results in that the drive wall makes a flexion deformation to have a V shape centering on the intermediate position in the depth direction in the drive wall. Further, due to such a flexion deformation of the drive wall, the ejection channel Ce deforms as if the ejection channel Ce bulges. As described above, due to the flexion deformation caused by a piezoelectric thickness-shear effect in the pair of drive walls, the volume of the ejection channel Ce increases. Further, by the volume of the ejection channel Ce increasing, the ink 9 is induced into the ejection channel Ce as a result.

Subsequently, the ink 9 induced into the ejection channel Ce in such a manner turns to a pressure wave to propagate to the inside of the ejection channel Ce. Then, the drive voltage Vd to be applied to the drive electrodes becomes 0 (zero) V at the timing at which the pressure wave has reached the nozzle hole Hn of the nozzle plate 112 (or timing around that timing). Thus, the drive walls are restored from the state of the flexion deformation described above, and as a result, the volume of the ejection channel Ce having once increased is restored again.

In such a manner, the pressure in the ejection channel Ce increases in the process that the volume of the ejection channel Ce is restored, and thus, the ink 9 in the ejection channel Ce is pressurized. As a result, the ink 9 shaped like a droplet is ejected (see FIG. 1) toward the outside (toward the recording paper P) through the nozzle hole Hn. The jet operation (the ejection operation) of the ink 9 in the inkjet head 1 is performed in such a manner, and as a result, the recording operation of images, characters, and so on to the recording paper P is performed.

### (B. Regarding Waveform Configuration of Drive Waveform)

Incidentally, in recent years, a complication in waveform configuration (configuration of the drive waveform) progresses in the drive signal to be applied to the inkjet head. The complicated waveform configuration is used for a variety of advantages such as reduction in drive noise generated when performing ejection, an increase in print quality due to a correction of a variation in an ejection performance, or suppression of crosstalk caused by simultaneous ejection of a large amount of droplets. For example, when performing the suppression of the crosstalk, regarding the ejection timing of the liquid to be ejected from the plurality of nozzle holes, a drive waveform corresponding to the original ejection timing and a drive waveform corresponding the ejection timing delayed from the original ejection timing are configured in advance. Further, for example, it is sufficient to perform the ejection drive at the original ejection timing regarding a predetermined nozzle array, and perform the ejection drive at the delayed ejection timing regarding other nozzle arrays. In order to perform such an ejection drive, it becomes necessary to, for example, set a plurality of waveform configurations to the drive circuit with respect to the same print data (image data), and at the same time, set which waveform configuration is used for ejecting the liquid using another method.

Here, it is relatively easy to provide a plurality of waveform configurations to the print data, but it cannot necessarily be said easy how to select one of the plurality of waveform configurations. Specifically, when a rule for selecting the waveform configuration is simple and unchanged, it is relatively easy. However, when, for example, the rule for selection is changed every time the ejection is performed, it is necessary to supply the inkjet head with the print data and additional print data associated with the print data. For example, when using the 4-bit print datum, when the four types of waveform configurations are provided to the single print datum, the 2-bit additional print datum becomes necessary, and thus, the substantive print datum consists of 6 bits.

Such an increase in an amount of information of the print datum becomes an obstacle when performing high-speed ejection in the inkjet head. In the current inkjet heads, the high-speed differential transmission is used in some cases from a viewpoint of aiming for an increase in printing speed, and a long transmission path with a cable or the like becomes necessary when the print data is transmitted at high speed from upstream of the inkjet head to the drive circuit. When using the high-speed differential transmission, the long transmission path becomes a factor for causing unstable signal transmission due to a power loss, and in particular, the higher the frequency of the signal transmission is, the more conspicuous. Here, when the amount of information of the print data increases as described above, the frequency of the signal transmission is made higher, and therefore, the stable operation of the inkjet head is sacrificed when performing the high-speed differential transmission. Therefore, in order to prevent such a phenomenon, it results in that, for example, a jitter cleaner function and a pre-emphasis function are implemented in a circuit upstream of the inkjet head, and at the same time, for example, an equalizing function is implemented at the inkjet head side, and therefore, it results in that an increase in cost is incurred.

In contrast, in order to transmit the print data without increasing the frequency, there can be cited a method of dividing the transmission path between the additional print data described above and the original print data. However, when the number of the transmission paths increases, a problem caused by a skew between the transmission paths occurs, and therefore, the increase in the amount of information of the print data is not preferable anyway.

However, in order to perform the print control high in degree of freedom, it becomes necessary to increase the amount of information of the print data. In contrast, when, for example, changing the ejection timing in each of the nozzle holes, there is no need to transmit the additional print data providing the waveform configuration to be applied to each of the nozzles are determined in advance.

In that context, it can be said that both of a printer which is high in degree of freedom of selection of the drive waveform, but requires an expensive circuit, and a printer which is low in degree of freedom of selection of the drive waveform, but is suppressed in cost of the circuit are in demand. Therefore, to a manufacturer of the inkjet head, it is desirable to be able to change the degree of freedom of selection of the drive waveform while suppressing the cost (a development cost or a manufacturing cost) using the same drive circuit.

### (C. Waveform Configuration of Present Embodiment)

Therefore, in the inkjet head 1 according to the present embodiment, the selected waveform data Dws are selected from the plurality of waveform data Dw using one of the waveform configuration signal Sw (Sw[1:0]) set in advance and the additional data configuration signal Spa defined by the additional data signal (the additional image datum Dp (Dp[5:4])) in each of the drive circuits 4a to 4d. Further, it is arranged that the drive signals Sd are generated based on the selected waveform data Dws.

Here, FIGS. 10A and 10B to FIGS. 12A and 12B are each a timing chart showing an example of the drive signal Sd in which the waveform configurations (the plurality of types of waveform configurations) using such waveform data Dw are performed. It should be noted that in FIGS. 10A and 10B to FIGS. 12A and 12B, the vertical axis represents the drive voltage Vd, and the horizontal axis represents time t. Further, the drive signals Sd shown in FIGS. 10A and 10B to FIGS. 12A and 12B are all examples of a so-called three-drop waveform, but this example is not a limitation, and it is possible to adopt other drop waveforms (such as a one-drop waveform, a two-drop waveform, or a waveform of four or more drops).

First, FIGS. 10A and 10B show a waveform example of the drive signal Sd in which the waveform configuration has been made using a plurality of types (two types in this example) of waveform data Dw for individually ejecting a plurality of types of ink (first ink 91 and second ink 92 as the two types of ink described above in this example). Specifically, FIG. 10A shows the waveform example of the drive signal Sd in which the waveform configuration for the first ink 91 has been made, and FIG. 10B shows the waveform example of the drive signal Sd in which the waveform configuration for the second ink 92 has been made.

In general, when the ink types are different from each other, so-called APs (on-pulse peaks: a half of a period of a natural vibration frequency of the ink in the ejection channel Ce, and a pulse width of a pulse signal with which the ejection characteristic becomes the best) are also different from each other. Therefore, the waveform example of the drive signal Sd for the first ink 91 shown in FIG. 10A and the waveform example of the drive signal Sd for the second ink 92 shown in FIG. 10B are different from each other in the pulse width at a H (high) level voltage VH, the pulse width at a L (low) level voltage VL, and the pulse width at a negative voltage VM.

Further, FIGS. 11A and 11B show a waveform example of the drive signal Sd in which the waveform configuration has been made using a plurality of (two types in this example) waveform data Dw for ejecting the ink 9 with droplet volumes (the volume ranges of the droplets) different from each other. Specifically, FIG. 11A shows the waveform example of the drive signal Sd in which the waveform configuration for a large droplet has been made, and FIG. 11B shows the waveform example of the drive signal Sd in which the waveform configuration for a small droplet has been made.

In the waveform example of the drive signal Sd for the large droplet shown in FIG. 11A, there is included a pulse at the negative voltage VM unlike the waveform example of the drive signal Sd for the small droplet shown in FIG. 11B. Thus, the droplet volume when ejecting the ink 9 is arranged to increase using the pulse at the negative voltage VM.

Further, FIGS. 12A and 12B show a waveform example of the drive signal Sd in which the waveform configuration has been made using a plurality of (two types in this example) waveform data Dw for ejecting the ink 9 at timings (ejection timings) different from each other. Specifically, FIG. 12A shows the waveform example of the drive signal Sd in which the waveform configuration for a normal ejection timing has been made, and FIG. 12B shows the waveform example of the drive signal Sd in which the waveform configuration for a delayed timing has been made.

In the waveform example of the drive signal Sd for the delayed timing shown in FIG. 12B, the ejection timing is slightly shifted (delayed) compared to the waveform example of the drive signal Sd for the normal timing shown in FIG. 12A. Thus, it is possible to reduce the energy of a pressure wave generated at the same time, and thus, it is possible to achieve the suppression of a so-called crosstalk. Further, it is also possible to reduce an instantaneous drive current (a peak value of the drive current) due to such a shift of the ejection timing, and there is also a role of reducing a peak value of an electric noise generated when, for example, driving to thereby prevent a malfunction in a peripheral circuit.

Here, considering when combining the drive signals Sd in which the variety of waveform configurations shown in FIGS. 10A and 10B to FIGS. 12A and 12B have been made with each other to apply the result to the four nozzle arrays Ana to And described above, the following is achieved as an example.

First, it is assumed that as the ink types, the first ink 91 and the second ink 92 as the two types of ink are individually ejected with the jet parts 11a, 11b described above, respectively. In other words, as the ink types, the two types of waveform configurations, namely the waveform configuration for the first ink 91 (FIG. 10A) and the waveform configuration for the second ink 92 (FIG. 10B), become necessary. Further, as the drive waveforms, there become necessary totally four types of waveform configurations, namely a non-ejection waveform, and three types of ejection waveforms (the three types consisting of the one-drop waveform, the two-drop waveform, and the three-drop waveform). Further, as the ejection timings, it is assumed that there are used the two types of waveform configurations, namely the waveform configuration for the normal ejection timing (FIG. 12A) and the waveform configuration for the delayed ejection timing (FIG. 12B) described above. Then, in this case, there become necessary totally 16 types (=(ink types: 2 types)×(drive waveforms: 4 types)×(ejection timings: 2 types)) of waveform configurations.

Further, it is assumed that these 16 types of waveform configurations are assigned to the waveform data W0 to W15 in the four waveform memories M0 to M3 in the waveform storage section 40 described above in, for example, the following manner:
Waveform memory M0: (for the first ink 91/for the normal ejection timing)→for the nozzle array Ana
Waveform memory M1: (for the first ink 91/for the delayed ejection timing)→for the nozzle array Anb
Waveform memory M2: (for the second ink 92/for the normal ejection timing)→for the nozzle array Anc
Waveform memory M3: (for the second ink 92/for the delayed ejection timing)→for the nozzle array And

Here, it is assumed that, for example, the waveform configuration signal Sw[1:0]=“00b” (b means binary expression) described above is set to the drive circuit 4a for generating the drive signals Sda corresponding to the nozzle array Ana. Similarly, it is assumed that, for example, the waveform configuration signal Sw[1:0]=“01b” is set to the drive circuit 4b for generating the drive signals Sdb corresponding to the nozzle array Anb, the waveform configuration signal Sw[1:0]=“10b” is set to the drive circuit 4c for generating the drive signals Sdc corresponding to the nozzle array Anc, and the waveform configuration signal Sw[1:0]=“11b” is set to the drive circuit 4d for generating the drive signals Sdd corresponding to the nozzle array And.

Such 2-bit waveform configuration signals Sw are respectively written to the drive circuits 4a to 4d in a lump via the control switching section 122 using the head configuration signal Ss. Further, it results in that the 16 types of waveform configurations described above are respectively stored in the waveform storage section 40 (the waveform memories M0 to M3) in each of the drive circuits 4a to 4d.

By using such a waveform configuration signal Sw[1:0], in the image data transmission section 21 in the print control section 2, it becomes possible to perform the processing of only the 2-bit signal on the image to be printed, and the selective use of the drive waveforms becomes unconsciously achieved. Therefore, it can be said that the convenience of the inkjet head 1 is enhanced.

On the other hand, when combining the two types of waveform configurations (the waveform configuration for the large droplet/the waveform configuration for the small droplet) shown in FIG. 11A and FIG. 11B with other types of waveform configurations, it results in that the volume range of the droplet is changed in accordance with the printing image. Therefore, in this case, it is more effective to use the additional data configuration signal Spa (the additional image datum Dp[5:4]) described above as the configuration signal instead of the waveform configuration signal Sw[1:0] described above.

Specifically, when, for example, a high-resolution image area in which it is more desirable to use small droplets and a solid image area in which it is more desirable to use large droplets are mixed in the printing image, it can be said that it is more efficient to use the additional data configuration signal Spa since the degree of freedom is ensured. It should be noted that, for example, the waveform configuration signal Sw can deal with a zone including a solid image in the printing area in some cases. Therefore, as described above, it can be said that it is desirable to arrange that which one of the waveform configuration signal Sw and the additional data configuration signal Spa is used can be changed as needed (using the selection control signal Swc).

It should be noted that in the example described above, it is possible to arrange that, for example, the waveform configuration signal Sw and the additional data configuration signal Spa are different in bit width from each other. In that case, it is necessary to set a predetermined value (e.g., “0”) to higher bit portion in the signal lower in bit width. Specifically, for example, when the bit width of the waveform configuration signal Sw is 4 bits, and at the same time, the bit width of the additional data configuration signal Spa is 2 bits, the following is performed. That is, by performing the processing of adding “00b” as the higher 2 bits to the values of “00b/01b/10b/11b” in the additional data configuration signal Spa to obtain “0000b/0001b/0010b/0011b,” it is arranged that the signal to be output always becomes 4 bits. It should be noted that it is sufficient for such processing to be executed in, for example, the selector 432.

### (D. Functions/Advantages)

In such a manner, in the inkjet head 1 according to the present embodiment, the selected waveform data Dws are selected from the plurality of waveform data Dw using one of the waveform configuration signal Sw set in advance and the additional data configuration signal Spa defined by the additional data signal described above in each of the drive circuits 4a to 4d. Further, the drive signals Sd are generated based on the selected waveform data Dws.

Thus, it becomes unnecessary to prepare a plurality of types of drive circuits 4a to 4d (the drive devices 4) for each of the inkjet heads 1 different in specification from each other. Specifically, for example, it is possible to make the drive circuits 4a to 4d deal with the inkjet heads 1 having a variety of types of specifications such as the inkjet head 1 which deals with a wide volume range (the droplet volume) by generating the drive signals Sd using the additional data configuration signal Spa, or the inkjet head 1 which is capable of simultaneously ejecting, for example, a plurality of types of ink 9 by generating the drive signals Sd using the waveform configuration signal Sw set in advance. Therefore, it becomes unnecessary to, for example, design the drive circuits 4a to 4d, or design and manufacture the boards (the I/F board 12 and the flexible boards 13a to 13d) in accordance with the individual inkjet head 1. As a result, in the present embodiment, it becomes possible to control the costs (the development cost and the manufacturing cost) of the inkjet head 1.

Further, in the present embodiment, since the waveform configuration signal Sw described above is defined by the signal (the head configuration signal Ss) different from the additional data configuration signal Spa described above, it becomes possible to change the content of the selected waveform data Dws from the outside of the inkjet head 1 using the head configuration signal Ss in accordance with, for example, the use situation of the user. As a result, it becomes possible to enhance the convenience of the user.

Further, in the present embodiment, since the selected waveform data Dws is selected using the selection control signal Swc, it becomes possible to change which one of the waveform configuration signal Sw and the additional data configuration signal Spa described above is used in accordance with, for example, the use situation of the user as needed. As a result, it becomes possible to enhance the convenience of the user.

In addition, in the present embodiment, since the image datum Dp is transmitted from the outside of the inkjet head 1 using the differential transmission (the high-speed differential transmission), the transmission rate of the image datum Dp to the inkjet head 1 increases. Thus, the ejection speed of the ink 9 increases, and thus, the high-speed printing is realized. As a result, it becomes possible to increase the productivity of the inkjet head 1.

Further, in the present embodiment, since the plurality of nozzle holes Hn is separated into the plurality of nozzle groups (the plurality of nozzle arrays Ana to And), and at the same time, the drive signals Sd (Sda to Sdd) are output for each of the nozzle arrays Ana to And, the following is achieved. That is, for example, it is possible to easily achieve the suppression of the crosstalk between the nozzle arrays Ana to And, the variation in ejection performance, and so on using the plurality of waveform data Dw while increasing the nozzle density in the inkjet head 1, and it becomes possible to improve the ejection performance of the inkjet head 1. Further, since the control by, for example, the image datum Dp becomes unnecessary when generating the drive signals Sd using such a plurality of waveform data Dw, it is possible to reduce the amount of information processing when performing the image processing in the outside (the print control section 2 as an upstream circuit) of the inkjet head 1. As a result, it becomes possible to reduce the power consumption in the printer 5 equipped with the inkjet head 1.

Further, in the present embodiment, when it is arranged that the plurality of types of waveform data Dw corresponding to the individual ejection of the plurality of types of ink 9 (e.g., the first ink 91 and the second ink 92 described above) is included in the plurality of waveform data Dw, the following is achieved. That is, it becomes unnecessary to individually change the waveform data Dw when individually ejecting such a plurality of types of ink 9, and thus, it is possible to easily use the appropriate waveform data Dw. Further, it is possible to easily prevent the confusion of the waveform data Dw corresponding to the types of the ink 9, and to easily correct the error when such confusion occurs. Due to the above, it becomes possible to enhance the convenience of the user.

In addition, in the present embodiment, when it is arranged that the plurality of types of waveform data Dw corresponding to the ejection timings (the ejection timings of the ink 9) different from each other is included in the plurality of waveform data Dw, the following is achieved. That is, when performing the ejection at such ejection timings different from each other, it is possible to change the waveform data Dw without using, for example, the image datum Dp. Thus, it is possible to achieve, for example, the suppression of the crosstalk and the reduction of the peak value of the drive current while suppressing the increase in the amount of the information of the image datum Dp. As a result, it becomes possible to further improve the ejection performance and the stability of the ejection operation in the inkjet head 1.

Further, in the present embodiment, when it is arranged that the plurality of types of waveform data Dw corresponding to the ejection with the droplet volumes (the volume ranges of the droplet) different from each other is included in the plurality of waveform data Dw, the following is achieved. That is, when performing the ejection with such droplet volumes different from each other, it is possible to easily perform the switching to the appropriate waveform data Dw. As a result, it becomes possible to enhance the convenience of the user.

### 2. Modified Example

Then, a modified example of the embodiment described above will be described. It should be noted that hereinafter, the same constituents as those in the embodiment are denoted by the same reference symbols, and the description thereof will arbitrarily be omitted.

### [Configuration]

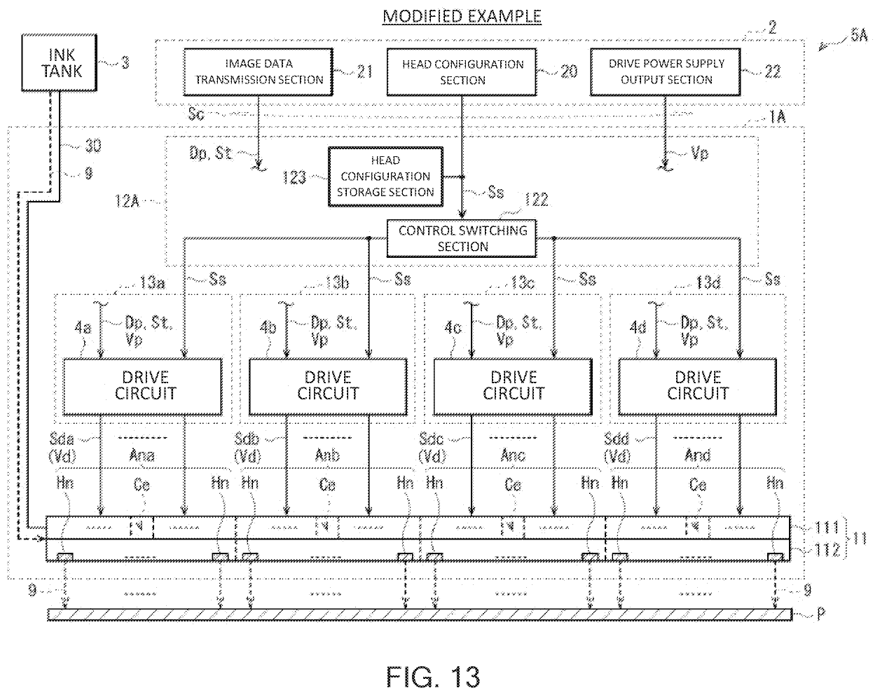

FIG. 13 is a block diagram showing a detailed configuration example of a printer 5A according to a modified example. The printer 5A according to this modified example is obtained by arranging that the inkjet head 1A is disposed instead of the inkjet head 1 in the printer 5 (see FIG. 4) according to the embodiment, and the rest of the configuration is made substantially the same.

It should be noted that the inkjet head 1A corresponds to a specific example of the “liquid jet head” in the present disclosure. Further, the printer 5A corresponds to a specific example of a “liquid jet recording device” in the present disclosure.

As shown in FIG. 13, the inkjet head 1A according to the modified example is obtained by arranging that an I/F board 12A is disposed instead of the I/F board 12 in the inkjet head 1 shown in FIG. 4, and the rest of the configuration is made substantially the same. Further, the I/F board 12A is obtained by further disposing a head configuration storage section 123 described hereinafter in the I/F board 12, and the rest of the configuration is made substantially the same.

The head configuration storage section 123 is a part for storing the head configuration signal Ss including the waveform configuration signal Sw described above. Further, the head configuration storage section 123 is arranged to develop the head configuration signal Ss stored therein to the drive circuits 4a to 4d via the control switch section 122 when, for example, starting up the inkjet head 1.

Further, it is possible to arrange that, for example, the head configuration storage section 123 generates the waveform data Dw (W0 to W15) described above by calculation, and at the same time, develops the waveform data Dw thus generated to the waveform storage section 40 in each of the drive circuits 4a to 4d.

It should be noted that such a head configuration storage section 123 is configured including, for example, a CPU (Central Processing Unit), and a nonvolatile memory such as an EEPROM (Electrically Erasable Programmable Read-Only Memory).

### [Functions and Advantages]

In such a modified example, it also becomes possible to obtain basically the same advantages due to substantially the same function as that of the embodiment. In other words, similarly to the embodiment, in the modified example, it also becomes possible to control the costs of the inkjet head 1A.

Further, in particular in the present modified example, since there is disposed the head configuration storage section 123 for storing the head configuration signal Ss, it is possible to automatically set the selected waveform data Dws at, for example, the startup of the inkjet head 1A and an arbitrary timing. As a result, it becomes possible to enhance the convenience of the user.

Further, as described above, for example, when it is arranged that the waveform data Dw are generated by calculation in the head configuration storage section 123, and are then developed to the waveform storage section 40, the following is achieved. That is, for example, it is possible to easily realize the suppression of the crosstalk and the reduction of the peak value of the drive current, and as a result, it becomes possible to further enhance the convenience of the user.

### 3. Other Modified Examples

The present disclosure is described hereinabove citing the embodiment and the modified example, but the present disclosure is not limited to the embodiment and so on, and a variety of modifications can be adopted.

For example, in the embodiment an so on described above, the description is presented specifically citing the configuration examples (the shapes, the arrangements, the number and so on) of each of the members in the printers 5, 5A and the inkjet heads 1, 1A, but what is described in the above embodiment and so on is not a limitation, and it is possible to adopt other shapes, arrangements, numbers and so on. Specifically, in the embodiment and so on described above, there is described the example when the four types of waveforms (the non-ejection waveform: one type, the ejection waveforms: three types) are set in each of the waveform memories M0 to M3, but this example is not a limitation, and it is also possible to arrange that, for example, the ejection waveforms are stored up to 15 types. Further, in the embodiment and so on described above, it is possible to store the 16 types of waveform data in each of the waveform memories M0 to M3, but this example is not a limitation, and it is possible to arrange that it is possible to store the plurality of types of waveform data such as those less than 16 types, or those more than 16 types. It should be noted that when setting, for example, the more than 16 types, the bit width of the image datum Dp increases accordingly. Further, in the embodiment and so on described above, there is described when the four waveform memories M0 to M3 are disposed in each of the waveform storage sections 40, but this example is not a limitation, and it is possible to arrange that, for example, the plurality of waveform memories other than the four waveform memories is disposed in each of the waveform storage sections 40. It should be noted that when, for example, it is arranged that five or more waveform memories are disposed in each of the waveform storage sections 40, the bit width of the waveform configuration signal Sw and the additional data configuration signal Spa accordingly increases as a result.

Further, for example, in the embodiment and so on described above, the description is presented specifically citing the configuration examples of the I/F board (a relay board), the flexible boards (the drive boards), the drive devices (the drive circuits), and so on, but these configuration examples are not limited to those described in the above embodiment and so on. For example, in the embodiment and so on described above, the description is presented citing when the drive board is the flexible board as an example, but the drive board can also be, for example, an inflexible board.

Further, in the embodiment and so on described above, the description is presented specifically citing the method of selecting the waveform configuration information (the waveform data), but the method described in the embodiment and so on described above is not a limitation, and it is also possible to arrange to, for example, perform the selection of the waveform configuration information using other methods. Further, in the above embodiment and so on, the description is presented citing the nozzle arrays Ana to And as an example of “nozzle groups” in the present disclosure, but this example is not a limitation, and it is also possible to set the plurality of nozzle groups using other grouping methods. Specifically, for example, it is possible to arrange that, for example, the plurality of nozzles arranged in one nozzle array belong to respective nozzle groups different from each other (e.g., the nozzle groups are separated between the odd-numbered nozzles and the even-numbered nozzles counted from an end part in the nozzle array). In other words, it is not required for the nozzle group to concentrate in one place on the surface of the nozzle plate.

Further, the numerical examples of the variety of parameters described in the embodiment and so on described above are not limited to the numerical examples described in the embodiment and so on, and can also be other numerical values.

Further, a variety of types of structures can be adopted as the structure of the inkjet head. Specifically, for example, it is possible to adopt a so-called side-shoot type inkjet head which ejects the ink 9 from a central portion in the extending direction of each of the ejection channels Ce in the actuator plate 111. Alternatively, it is possible to adopt, for example, a so-called edge-shoot type inkjet head for ejecting the ink 9 along the extending direction of each of the ejection channels Ce. Further, the type of the printer is not limited to the type described in the embodiment and so on described above, and it is possible to apply a variety of types such as an MEMS (Micro Electro-Mechanical Systems) type.

Further, for example, it is possible to apply the present disclosure to either of an inkjet head of a circulation type which uses the ink 9 while circulating the ink 9 between the ink tank and the inkjet head, and an inkjet head of a non-circulation type which uses the ink 9 without circulating the ink 9.

Further, the series of processing described in the above embodiment and so on can be arranged to be performed by hardware (a circuit), or can also be arranged to be performed by software (a program). When arranging that the series of processing is performed by the software, the software is constituted by a program group for making the computer perform the functions. The programs can be incorporated in advance in the computer described above to be used by the computer, for example, or can also be installed in the computer described above from a network or a recording medium to be used by the computer.

Further, in the embodiment and so on described above, the description is presented citing the printer 5 (the inkjet printer) as a specific example of the “liquid jet recording device” in the present disclosure, but this example is not a limitation, and it is also possible to apply the present disclosure to other devices than the inkjet printer. In other words, it is also possible to arrange that the “liquid jet head” (the inkjet head) of the present disclosure is applied to other devices than the inkjet printer. Specifically, it is also possible to arrange that the “liquid jet head” of the present disclosure is applied to a device such as a facsimile or an on-demand printer.

In addition, it is also possible to apply the variety of examples described hereinabove in arbitrary combination.

It should be noted that the advantages described in the present specification are illustrative only, but are not a limitation, and other advantages can also be provided.

Further, the present disclosure can also take the following configurations.

<1> A drive circuit configured to output a drive signal to be applied to a liquid jet head, comprising: a waveform storage section configured to store a plurality of pieces of waveform configuration information; a waveform selection section which is configured to select one of the plurality of pieces of waveform configuration information stored in the waveform storage section, and which is configured to output the waveform configuration information selected as selected waveform configuration information; and a signal generation section configured to generate the drive signal configured to jet liquid, based on the selected waveform configuration information output from the waveform selection section and an image datum input from an outside of the liquid jet head, wherein the waveform selection section selects the selected waveform configuration information from the plurality of pieces of waveform configuration information, using one of a first configuration signal set in advance and a second configuration signal defined by an additional data signal included in the image datum.

<2> The drive circuit according to <1>, wherein the first configuration signal is defined by a head configuration signal as a signal different from the additional data signal.

<3> The drive circuit according to <1> or <2>, wherein the waveform selection section selects the selected waveform configuration information, using a selection control signal configured to define which one of the first configuration signal and the second configuration signal is used.

<4> The drive circuit according to any one of <1> to <3>, wherein the image datum is transmitted from the outside of the liquid jet head using differential transmission.

<5> A liquid jet head comprising: the drive circuit according to any one of <1> to <4>; and a jet section which is configured to jet the liquid based on the drive signal output from the drive circuit, and which has a plurality of nozzles.

<6> The liquid jet head according to <5>, wherein the plurality of nozzles is separated into a plurality of nozzle groups, and the drive circuit outputs the drive signal for each of the nozzle groups.

<7> The liquid jet head according to <5> or <6>, wherein the plurality of pieces of waveform configuration information includes a plurality of types of first waveform configuration information for individually ejecting a plurality of types of the liquid.

<8> The liquid jet head according to any one of <5> to <7>, wherein the plurality of pieces of waveform configuration information includes a plurality of types of second waveform configuration information for ejecting the liquid at timings different from each other.

<9> The liquid jet head according to any one of <5> to <8>, wherein the plurality of pieces of waveform configuration information includes a plurality of types of third waveform configuration information for ejecting the liquid with droplet volumes different from each other.

<10> The liquid jet head according to any one of <5> to <9>, further comprising a head configuration storage section configured to store a head configuration signal including the first configuration signal.

<11> The liquid jet head according to <10>, wherein the head configuration storage section is configured to generate the waveform configuration information by calculation, and develop the waveform configuration information generated to the waveform storage section.

<12> A liquid jet recording device comprising the liquid jet head according to any one of <5> to <11>.

What is claimed is:

1. A drive circuit configured to output a drive signal to be applied to a liquid jet head, comprising:
a waveform storage section configured to store a plurality of pieces of waveform configuration information;
a waveform selection section which is configured to select one of the plurality of pieces of waveform configuration information stored in the waveform storage section, and which is configured to output the waveform configuration information selected as selected waveform configuration information; and
a signal generation section configured to generate the drive signal configured to jet liquid, based on the selected waveform configuration information output from the waveform selection section and an image datum input from an outside of the liquid jet head, wherein
the waveform selection section selects the selected waveform configuration information from the plurality of pieces of waveform configuration information, using one of a first configuration signal set in advance and a second configuration signal defined by an additional data signal included in the image datum.

2. The drive circuit according to claim 1, wherein
the first configuration signal is defined by a head configuration signal as a signal different from the additional data signal.

3. The drive circuit according to claim 1, wherein
the waveform selection section selects the selected waveform configuration information, using a selection control signal configured to define which one of the first configuration signal and the second configuration signal is used.

4. The drive circuit according to claim 1, wherein
the image datum is transmitted from the outside of the liquid jet head using differential transmission.

5. A liquid jet head comprising:
the drive circuit according to claim 1; and
a jet section which is configured to jet the liquid based on the drive signal output from the drive circuit, and which has a plurality of nozzles.

6. The liquid jet head according to claim 5, wherein
the plurality of nozzles is separated into a plurality of nozzle groups, and
the drive circuit outputs the drive signal for each of the nozzle groups.

7. The liquid jet head according to claim 5, wherein
the plurality of pieces of waveform configuration information includes a plurality of types of first waveform configuration information for individually ejecting a plurality of types of the liquid.

8. The liquid jet head according to claim 5, wherein
the plurality of pieces of waveform configuration information includes a plurality of types of second waveform configuration information for ejecting the liquid at timings different from each other.

9. The liquid jet head according to claim 5, wherein
the plurality of pieces of waveform configuration information includes a plurality of types of third waveform configuration information for ejecting the liquid with droplet volumes different from each other.

10. The liquid jet head according to claim 5, further comprising a head configuration storage section configured to store a head configuration signal including the first configuration signal.

11. The liquid jet head according to claim 10, wherein
the head configuration storage section is configured to
generate the waveform configuration information by calculation, and
develop the waveform configuration information generated to the waveform storage section.

12. A liquid jet recording device comprising the liquid jet head according to claim 5.
